(19) United States
(12) Patent Application Publication
(10) Pub. No.: US 2010/0206680 A1
(43) Pub. Date: Aug. 19, 2010

(54) Shaft rotating mechanism for mower

(75) Inventor: You-Nan Hung, Taichung County (TW)

Correspondence Address: CHARLES E. BAXLEY, ESQUIRE, 90 JOHN STREET, SUITE 309, NEW YORK, NY, 10038, US

(73) Assignee: Shunchi Crankshaft Co., Ltd.

(21) Appl. No.: 12/378,699

(22) Filed: Feb. 18, 2009

(51) Int. Cl. F16D 11/14; F16H 55/06

(52) U.S. Cl. 192/69; 74/431

(57) ABSTRACT

A shaft rotating mechanism for a mower is disclosed. The shaft rotating mechanism comprises a housing; a driving shaft settled in the housing; a driving gear rotatably mounted around the driving shaft and comprising a plurality of first one-way teeth; a shiftable gear unrotatably mounted around the driving shaft and comprising a plurality of second one-way teeth; a clutch settled for engaging or disengaging the shiftable gear with or from the driving gear; and a worm having one end connected with a power source of the mower and an opposite end coupled with the driving gear for driving the driving gear to rotate. Thereby, the clutch, when operated, moves the shiftable gear along the driving shaft to make the shiftable gear couple with the driving gear so that the driving shaft is driven by the driving gear to rotate.

### BACKGROUND OF THE INVENTION

1. Technical Field

The present invention relates to mowers, and more particularly, to a shaft rotating mechanism that has simplified structure and improved transmission efficiency for being applied to a mower so as to transmit power from a power source to a shaft, thereby rotating the shaft.

2. Description of Related Art

Conventionally, a mower comprises three main portions, namely a mowing mechanism, wheels and a handle portion. In use, a user holds the handle portion and exerts a forward force thereon to make the mower on the rolling wheels move forward. Meantime, a power source of the mowing mechanism drives blades to rotate with high speed so as to mow and the mowing is then expel from the mower along the rotating direction of the blades.

While such a conventional mower is efficient in mowing, the user thereof nevertheless has to spend energy to advance the mower on the ground, thus causing mowing a wide yard a laborious work.

In view of this, U.S. Pat. No. 6,679,036, titled “Drive gear shaft structure of a self-moving type mower”, having the same assignee of the present invention, disclosed a self-propelled mower in wherein two transmission taper blocks use their taper surfaces to urge against taper holes of a gear on the drive gear shaft so that friction upon the taper surfaces transmits power and in turn drive the shaft to rotate.

However, after put into practical application, the high working temperature caused by the friction upon the taper surfaces with a side effect of reducing the durability of the components needs to be remedied. Beside, the patented structure is also defective for its inferior transmission efficiency and complex components, thus needing to be improved.

### SUMMARY OF THE INVENTION

In view of the need, the primary objective of the present invention is to provide a shaft rotating mechanism for a mower so as to eliminate problems of the prior art, such as the inferior transmission efficiency and component complexity.

The shaft rotating mechanism of the present invention comprises a housing receiving therein a driving shaft, a driving gear rotatably mounted around the driving shaft and comprising a plurality of first one-way teeth; a shiftable gear unrotatably mounted around the driving shaft and comprising a plurality of second one-way teeth, a clutch settled on the housing for controlling the driving gear and the shiftable gear to engage or disengage mutually; and a worm piercing into the housing for driving the driving gear to rotate. Thereby, when operated, the clutch makes the shiftable gear along the driving shaft move toward and get coupled with the driving gear so that the driving gear driven by the worm rotates the shiftable gear and in turn rotates the driving shaft. Hence, the present invention allows improved power transmission effect and enhanced structural strength.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of a shaft rotating mechanism of the present invention;

FIG. 2 is an exploded view of the shaft rotating mechanism of the present invention;

FIG. 3 is a perspective view of a shiftable gear of the shaft rotating mechanism of the present invention;

FIG. 4 is an axial plane view of the shiftable gear;

FIG. 5 is a perspective view of a driving gear of the shaft rotating mechanism of the present invention;

FIG. 6 is an axial plane view of the driving gear;

FIG. 7 is a schematic drawing showing the shaft rotating mechanism in its idling position; and

FIG. 8 is a schematic drawing showing the shaft rotating mechanism in its operating position.

### DETAILED DESCRIPTION OF THE PREFERRED EMBODIMENTS

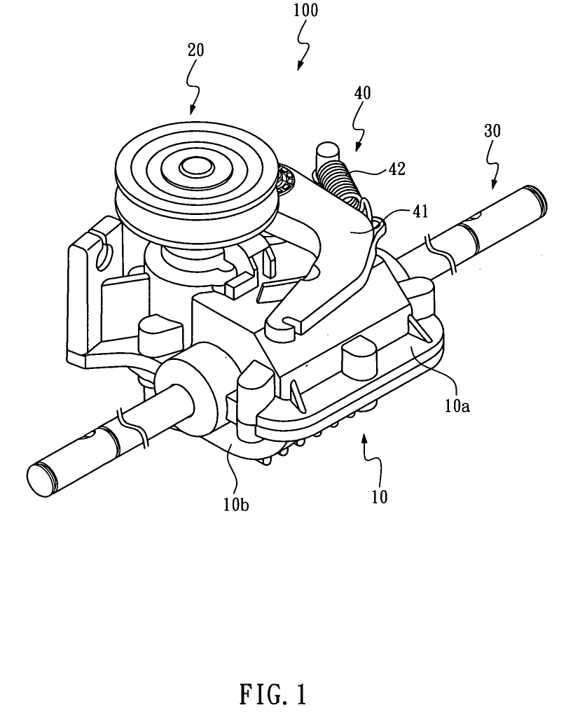

Please refer to FIG. 1 for a perspective view of a shaft rotating mechanism for a mower according to the present invention. The shaft rotating mechanism 100 comprises a housing 10, a pulley 20, a driving shaft 30 and a clutch 40. The pulley 20 is connected with and driven by a power source (not shown) of the mower so as to rotate. The clutch 40 allows the pulley 20 to mechanically connect and rotate the driving shaft 30.

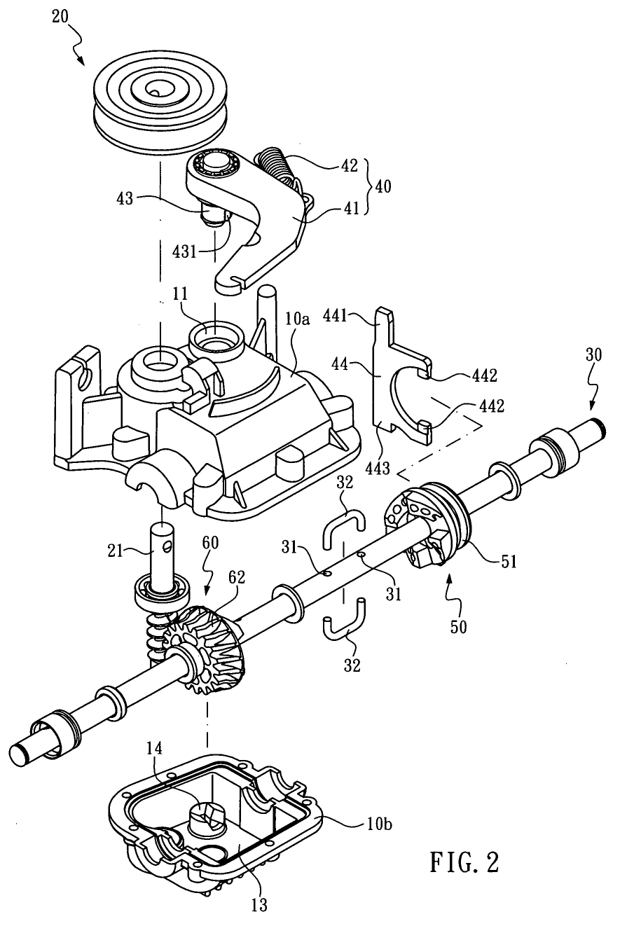

FIG. 2 is an exploded view of the shaft rotating mechanism of the present invention. As can be seen therein, the housing 10 comprises an upper member 10a and a lower member 10b. The upper member 10a is formed with an installation hole 11. A closed accommodating space 13 is formed between the assembled upper and lower members 10a, 10b for receiving lubricant, which takes 40% of capacity of the accommodating space 13 and functions for thermal dispersion, lubrication and component cleaning. Besides, a pedestal 14 is raised from a bottom of the accommodating space 13.

The pulley 20 is rotatably mounted onto the upper member 10a. The pulley 20 is so connected with a worm 21 that the worm 21 is driven by the pulley 20 to rotate.

The driving shaft 30 is settled between the upper and lower members 10a, 10b. A plurality of fastening holes 31 are provided at predetermined locations on the driving shaft 30. In the present invention, two said fastening holes 31 are formed on the driving shaft 30. Two U-shaped retainers 32 have legs thereof fixed in the fastening holes 31 by a mechanical means or any equivalent means.

The clutch 40 includes a pulling rod 41, a wing 44 and an extension spring 42. The extension spring 42 has one end connected with the upper member 10a and an opposite end connected with the pulling rod 41. A sleeve 43 assembled to one end of the pulling rod 41 is retained in the installation hole 11 of the upper member 10a. Moreover, the sleeve 43 is formed with a slot 431.

The wing 44 includes a lower salient 443 formed at a lower edge thereof for being inserted into the pedestal 14 of the lower member 10b, and includes an upper salient 441 formed at an upper edge thereof for being inserted into the sleeve 43 on the pulling rod 41 so that the wing 41 is fixedly positioned with respect to the pulling rod 41. That is, the wing 41 and the pulling rod 41, when assembled, move as an integral piece.

The wing 44 has a substantially C-shaped body with an opened side formed with a pair of arms 422 that jointly hold a shiftable gear 50. The shiftable gear 50 comprises an annular groove 51 for partially receiving the wing 44 and thus gets retained by the arms 442. Thereby, the pulling rod 41 drives the wing 44 to swing when pulled, and returns to its initial position due to resilience of the extension spring 42 when released.

FIG. 3 is a perspective view of the shiftable gear of the shaft rotating mechanism of the present invention. The shiftable gear 50 comprises an axial hole 52 so that the shiftable gear 50 is unrotatably yet shiftably mounted around the driving shaft 30. Four second one-way teeth 53 are provided at one side of the shiftable gear 50. Each said one-way tooth 53 has a higher end and a lower end, and has a plurality of vents 54.

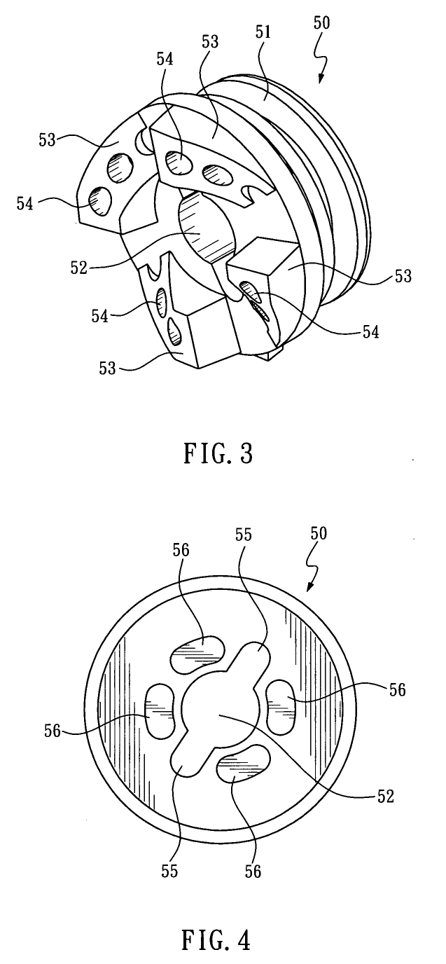

FIG. 4 is a plane view of the shiftable gear 50. The axial hole 52 of the shiftable gear 50 is flanked by and intercommunicated with two positioning slots 55. Besides, a plurality of recesses 56 are arranged around the axial hole 52. Therein, when the wing 44 is swung, due to the fact that the retainers 32 of the driving shaft 30 are retained by the positioning slots 55, the shiftable gear 50 moves axially along the driving shaft 30 while retaining from rotation.

Additionally, a driving gear 60 is rotatably provided around the driving shaft 30 and aligned with the shiftable gear 50. The driving gear 60 is engaged with and driven by the worm 21.

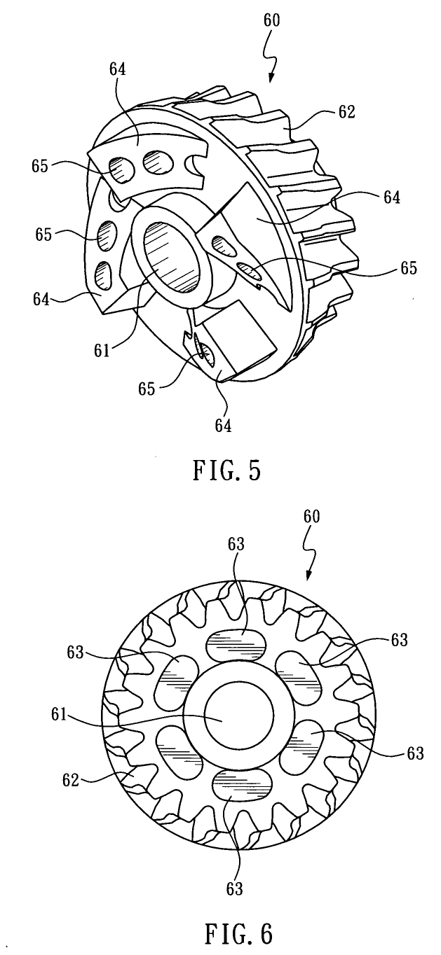

FIG. 5 is a perspective view of the driving gear 60 of the shaft rotating mechanism of the present invention. The driving gear 60 has an axial hole 61 so that the driving gear 60 is rotatably mounted around the driving shaft 30. The driving gear 60 has peripherally a worm gear portion 62 for engaging with the worm 21 and a side of the driving gear 60 is integrally formed with four first one-way teeth 64 each having a plurality of vents 65.

FIG. 6 is a plane view of the driving gear 60 showing a plurality of recesses 63 provided an opposite side of the driving gear 60.

The first one-way teeth 64 of the driving gear 60 face the second one-way teeth 53 of the shiftable gear 50 so that when the shiftable gear 50 moves toward the driving gear 60, the first and second one-way teeth 64, 53 come to couple with each other. Consequently, the shiftable gear 50 can be driven by the driving gear 60, and in turn the driving shaft 30 can be driven to rotate.

It is to be noted that both the shiftable gear 50 and the driving gear 60 are made of a compound material containing 70%˜80% nylon and 30%˜20% fiber through an injection molding process so that the shiftable gear 50 and the driving gear 60 possess the characters of high-heat resistance and high strength. Meantime, provision of the recesses 56, 63 and the vents 54, 65 facilitates not only saving the material, reducing overall weight of the components, and increasing overall thermal dispersion surface area, but also preventing deformation of the components under cool contract or uneven thermal dispersion.

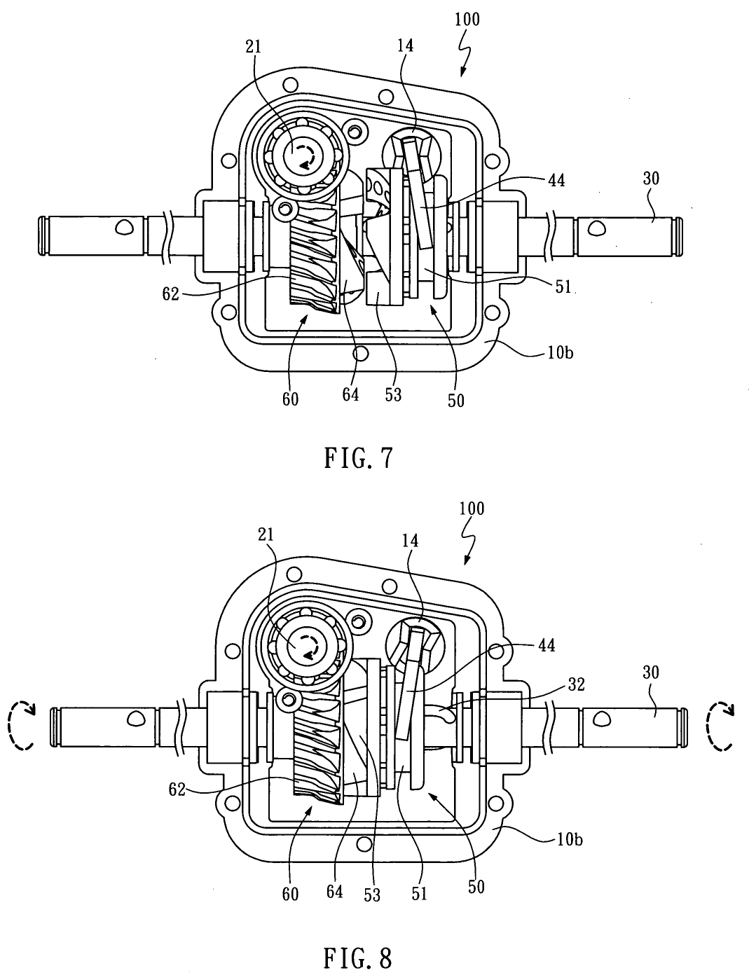

FIG. 7 is a schematic drawing showing the shaft rotating mechanism in its idling position. As can be seen therein, when the wing 44 is now such placed that the shiftable gear 50 and the driving gear 60 are separated by a predetermined distance. At this time, the driving gear 60 is idling, as indicated by the dotted arrow in the drawing, and the driving shaft 30 being independent from the driving gear 60 now stays still.

FIG. 8 is a schematic drawing showing the shaft rotating mechanism in its operating position. As can be seen therein, at this time, the wing 44 is such placed that the shiftable gear 50 moves along the driving shaft 30 and gets engaged with the driving gear 60. Thus, the driving gear 60 is now capable of transmitting power to the shiftable gear 50, so that the shiftable gear 50 in turn drives the driving shaft 30 to rotate, as indicated by the dotted arrows in the drawing.

Therefore, the simplified power transmission path, from the worm 21, the driving gear 60, the shiftable gear 50 through the driving shaft 30, realizes more direct power transmission and reduces power loss.

To sum up, the shaft rotating mechanism of the present invention has the driving gear 60 composed of integrally formed worm gear portion 62 and the first one-way teeth 64, so as to accomplish a simplified transmission mechanism. In operation, power is transmitted from the worm 21, the driving gear 60, and the shiftable gear 50 to the driving shaft 30, thereby making power transmission more direct and reducing power loss.

Since the shiftable gear 50 and the driving gear 60 are made of the compound material containing nylon and fiber in proper proportion and formed with the vents 54, 65 and recesses 56, 63, the they have all the advantages related to light weight, high-heat resistance and high strength.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A shaft rotating mechanism for a mower, the shaft rotating mechanism comprising:
a housing comprising an upper member and a lower member;
a driving shaft settled between the upper and lower members;
a driving gear rotatably mounted around the driving shaft and comprising a worm gear portion and a plurality of first one-way teeth that are integrally formed on the driving gear;
a shiftable gear unrotatably yet shiftably mounted around the driving shaft and comprising an annular groove and a plurality of second one-way teeth, wherein the annular groove and a plurality of second one-way teeth are integrally formed on the shiftable gear and the second one-way teeth face the first one-way teeth;
a clutch settled on the housing for engaging or disengaging the shiftable gear with or from the driving gear; and
a worm having one end connected with a power source of the mower and an opposite end coupled with the worm gear portion of the driving gear for driving the driving gear to rotate;
whereby, the clutch, when operated, moves the shiftable gear along the driving shaft to make the shiftable gear couple with the driving gear so that the driving shaft is driven by the driving gear to rotate.

2. The shaft rotating mechanism of claim 1, wherein the driving gear and the shiftable gear are made of a compound material containing nylon and fiber through an injection molding process.

3. The shaft rotating mechanism of claim 1, wherein the driving gear is formed with a plurality of recesses for reducing deformation caused in the injection molding process.

4. The shaft rotating mechanism of claim 1, wherein each of the first and second one-way teeth has a plurality of vents for thermal dissipation.

5. The shaft rotating mechanism of claim 1, wherein the shiftable gear is formed with a plurality of recesses for reducing deformation caused in the injection molding process.

6. The shaft rotating mechanism of claim 1, wherein each of the first and second one-way teeth has a higher end and a lower end.

7. The shaft rotating mechanism of claim 1, wherein two retainers are provided on the driving shaft and the axial hole of the shiftable gear is flanked by two positioning slots so that when the shiftable gear is mounted around the driving shaft, the shiftable gear is axially movable with respect to the driving shaft and retained from rotating with respect to the driving shaft.

8. The shaft rotating mechanism of claim 7, wherein the retainers are U-shaped retainers and a plurality of fastening holes on the driving shaft allow the retainers to be inserted and positioned therein.

9. The shaft rotating mechanism of claim 1, wherein the clutch includes a pulling rod, a wing and an extension spring, in which the pulling rod has one end controlling the wing to swing and the wing is retained in the annular groove of the shiftable gear so that when the wing is swung, it moves the shiftable gear along the driving shaft to make the shiftable gear get coupled with the driving gear, and in which the shiftable gear and the driving gear are normally separated due to the extension spring.

10. The shaft rotating mechanism of claim 9, wherein a sleeve is assembled to the pulling rod, in which the sleeve has a slot and the pulling rod has an upper salient formed at a top thereof for being inserted into the sleeve.

11. The shaft rotating mechanism of claim 9, wherein the wing includes a lower salient while a pedestal is formed at an inner surface of the lower member of the housing so that the lower salient is retained by the pedestal.

12. The shaft rotating mechanism of claim 9, wherein the wing has a C-shaped body with an opened side formed with a pair of arms to be received in the annular groove of the shiftable gear so that the wing is capable of pushing the shiftable gear to move axially.

13. The shaft rotating mechanism of claim 1, wherein a closed accommodating space is formed between the assembled upper and lower members for receiving lubricant.
